(19) United States
(12) Patent Application Publication
(10) Pub. No.: US 2012/0292411 A1
(43) Pub. Date: Nov. 22, 2012

(54) Pneumatic spray gun with finger adjustable spray control

(76) Inventor: Shiqi Zhu, Ashland, VA (US)

(21) Appl. No.: 13/067,263

(22) Filed: May 19, 2011

(51) Int. Cl. B05B 7/12; B05B 7/26

(52) U.S. Cl. 239/583; 239/337; 239/526; 239/569

(57) ABSTRACT

An improved paint spray gun, including high volume and low pressure air paint spray guns, siphon-type paint spray guns, and gravity-fed-type spray guns, in which the spray pattern may be adjusted single-handedly with the gripping hand while in use. The invention includes a thumb and/or finger adjustable wheel rotatably mounted in the spray gun that is accessible while gripping the spray gun and may be used to adjust the spray characteristics of paint or similar liquid being sprayed.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The invention relates to improved paint spray guns, including spray guns using low pressure and high volume air for atomizing the paint, whereby their spray pattern may be adjusted single-handedly with the gripping hand while in use. The apparatus includes a thumb and/or finger adjustable wheel that is accessible to adjust the spray characteristics of the paint or similar liquid being ejected therefrom.

### BACKGROUND OF THE INVENTION

Spray guns, especially those used with spray painting systems, atomize the liquid paint by means of air which enters a nozzle area via a chamber surrounding a fluid nozzle. The atomizing air is then impinged at the end of the chamber and exits via a central aperture located at the end of the chamber. Utilizing the physical phenomenon of the Venturi effect, paint is drawn from a reservoir and atomized by the pressure gradient created by the accelerating air as it exits the spray gun nozzle via the aperture.

Numerous factors affect the volume of liquid being ejected from conventional spray gun nozzles and the pattern at which it sprays, including the viscosity of the liquid, the cubic feet per minute (c.f.m.) of air being supplied by the compressor, the pressure at which that air is being regulated, regulation of the air by control valves in the spray gun itself, and modulation of the spray gun trigger by the user. Hence, while effective for quickly and efficiently covering a surface with paint, varnish, shellac, or similar liquid, the spray pattern of these devices can be difficult to control. Each parameter is independently adjustable with the result that adjusting the spray pattern is a complex, time consuming, and multi-handed procedure, entailing repeated trial and error. Too much liquid or too large a spray pattern results in overspray, damage to surrounding items, and wasted materials. Conversely, insufficient volumes of liquid or too small a spray pattern produces uneven coverage requiring repeated passes of the gun. In particular, the flow regulator of previously known devices requires two hands to operate, with the user grasping the device in one hand while the other is employed in manipulating the regulator control itself

What is needed is a mechanism by which the spray pattern may be adjusted “on-the-fly.” Preferably, these adjustments may be carried out single-handedly. Additionally, the resulting spray pattern should be consistent and repeatable.

### SUMMARY OF THE INVENTION

The present invention is an improvement with regard to pneumatic paint sprayers, in particular including those utilizing high volume low pressure air sources, and including gravity fed as well as siphon type apparatuses. The improvement includes a thumb and/or finger adjustable mechanism for control of the trigger of the device whereby single-handed manipulation of a thumbscrew by the user controls the travel of the device trigger. Modulation of the trigger thereby allows the user to single handedly control the spray pattern produced by the apparatus in a consistent and repeatable manner.

It is an object of the invention to provide an easily adjustable pneumatic spray gun;

It is another object of the invention to provide a pneumatic spray gun with finger adjustable spray control;

It is yet another object of the invention to provide a pneumatic spray gun that may be adjusted single-handedly,

It is still another object of the invention to provide a pneumatic spray gun having a consistent, repeatable spray pattern; and,

It is finally an object of the invention to provide a pneumatic spray gun with a trigger stop.

The invention will be better understood and objects other than those set forth above will become apparent when consideration is given to the following detailed description thereof. Such description makes reference to the annexed drawings wherein.

### BRIEF DESCRIPTION OF THE DRAWINGS

FIG. 1 is a perspective view of an embodiment using a bottom mounted paint can;

FIG. 2 is a perspective view of an embodiment using a top mounted paint can;

FIG. 3 is a cutaway view of the embodiment shown in FIG. 1.

FIG. 4 is a detailed elevation view of the thumbscrew adjustable trigger stop of the present invention; and,

FIG. 5 is a front, three quarters perspective view of the thumbscrew adjustable trigger stop shown in FIG. 4.

### DETAILED DESCRIPTION OF THE INVENTION

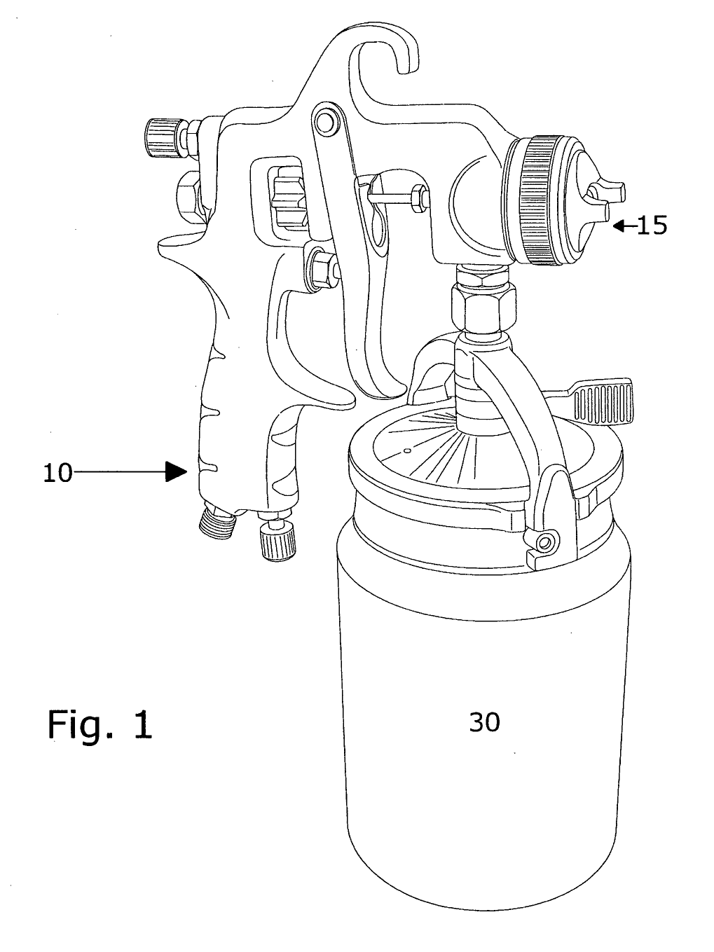

The preferred embodiments and best mode of the invention are shown in FIGS. 1 through 5. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

This invention may be constructed from any suitable material including but not limited to appropriate metals, plastics and other polymers, ceramics, and combinations thereof.

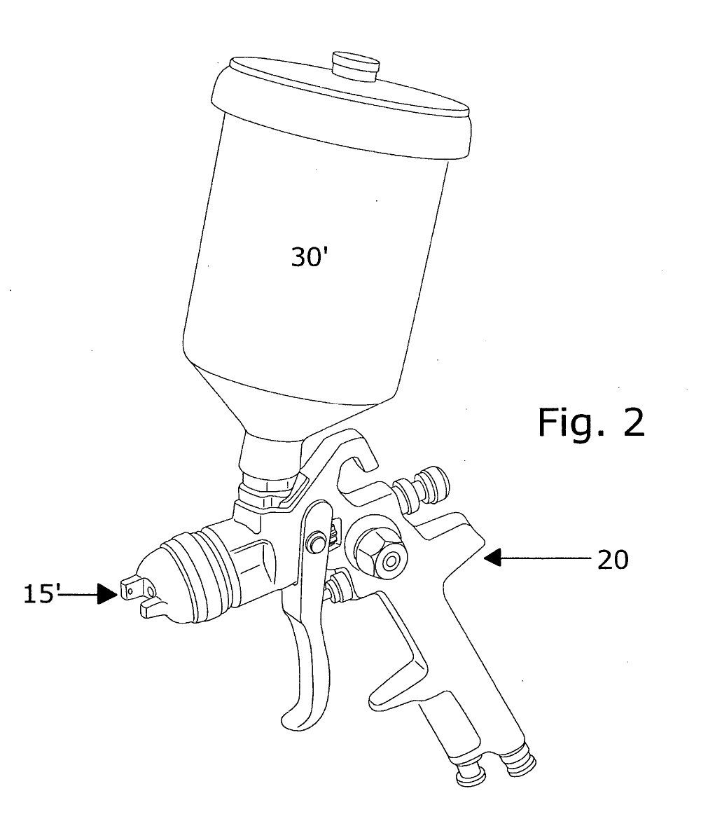

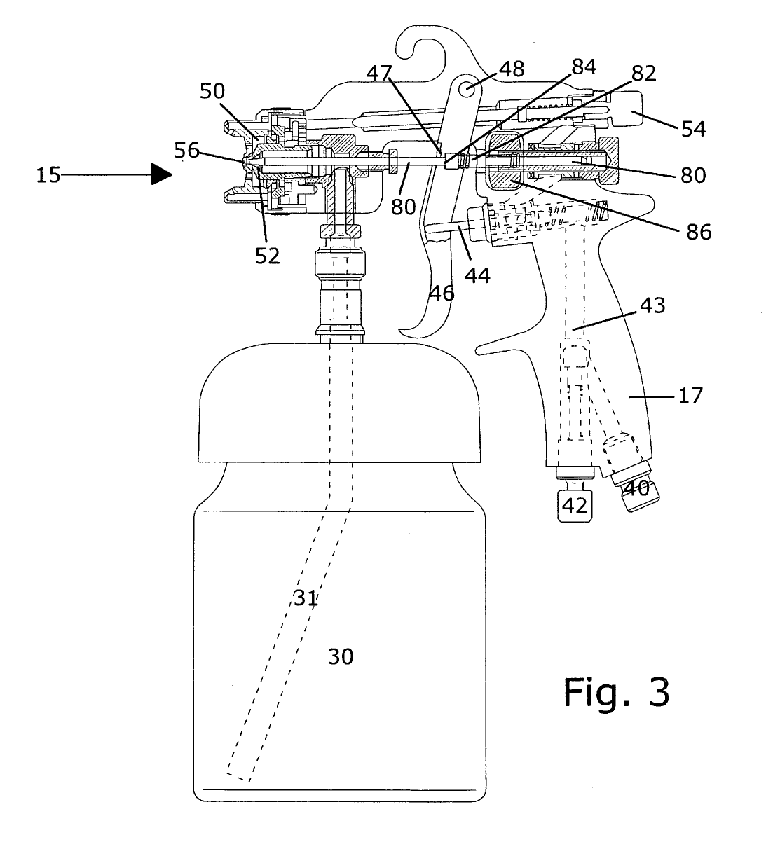

Turning to FIGS. 1 and 2, a spray gun with a bottom paint can mount 10 and a spray gun with a top paint can mount 20 are respectively shown. Both spray guns function identically with regard to the present invention and differ essentially only in the mechanism by which the liquid to be sprayed is delivered to the spraying assembly 15, 15′. FIG. 1 depicts a siphon-style spray gun 10 with a paint can or reservoir 30 mounted below the spraying assembly 15 so that the liquid being sprayed is drawn into the spraying assembly 15 via a siphon tube 31 (see FIG. 3) operated via the vacuum created by operation of the spraying assembly 15. FIG. 2 depicts a gravity-fed-style spray gun 20, including a paint can or hopper 30′ mounted above the spraying assembly 15′. Instead of the siphon mechanism used with regard to the siphon-style device 10 of FIG. 1, an aperture (not shown) in the hopper 30′ allows the to-be-sprayed material to essentially drip into the spraying assembly 15′. Absent the improvements of the present invention, both apparatuses 10 and 20 operate in a conventional manner understood by those skilled in the art.

In FIG. 3, the apparatus of the siphon-style spray gun 10 is shown in a cutaway view. Included is a reservoir 30 and siphon tube 31 used in a conventional manner to supply paint, varnish, or similar liquid to the spraying assembly 15. The spraying assembly 15 operates in a generally conventional manner that will be understood by those skilled in the art and includes a fluid nozzle 52 in communication with the reservoir 30 and siphon tube 31. An air nozzle 50 generally surrounds the fluid nozzle 52 such that a vacuum created by air entering the nozzle and thereafter being expelled from the spray aperture 56 tends to draw liquid up from the reservoir 30 via the siphon tube 31. The liquid drawn through the siphon tube 31 subsequently mixes with and is atomized by the air from the air nozzle 50 with the result that the atomized paint, varnish, shellac, or similar liquid is ejected from the spray aperture 56 of the spraying assembly 15. The amount of liquid being supplied to the spraying assembly 15 is controlled by a needle valve screw 80.

The pistol grip 17 of the inventive apparatus generally comprises the assembly for introduction of the compressed air or similar gas used for operation of the apparatus. An air inlet 40 is provided at the base of the pistol grip 17 whereby an air supply hose (not shown) may be attached in a conventional manner, for example using ¼ inch or ⅜ inch NPT (National Pipe Thread) fittings known to those skilled in the art. Gross adjustment of air pressure is regulated by an air adjustment screw 42 in communication with the air inlet 40 via an air channel 43 defined within the pistol grip 17. Additionally, a secondary air adjustment screw 54 is provided in the upper body portion of the spray gun 10. A plunger valve 44 impinging on the air channel 43 facilitates infinitely adjustable control of the air supplied to the apparatus 10 whereby reciprocal manipulation by the operator of the trigger 46 rotating about its trigger pivot 48 and engaging the plunger valve 44 causes air to enter the spraying assembly 15 as described above with the result that atomized liquid is ejected from the spraying assembly 15.

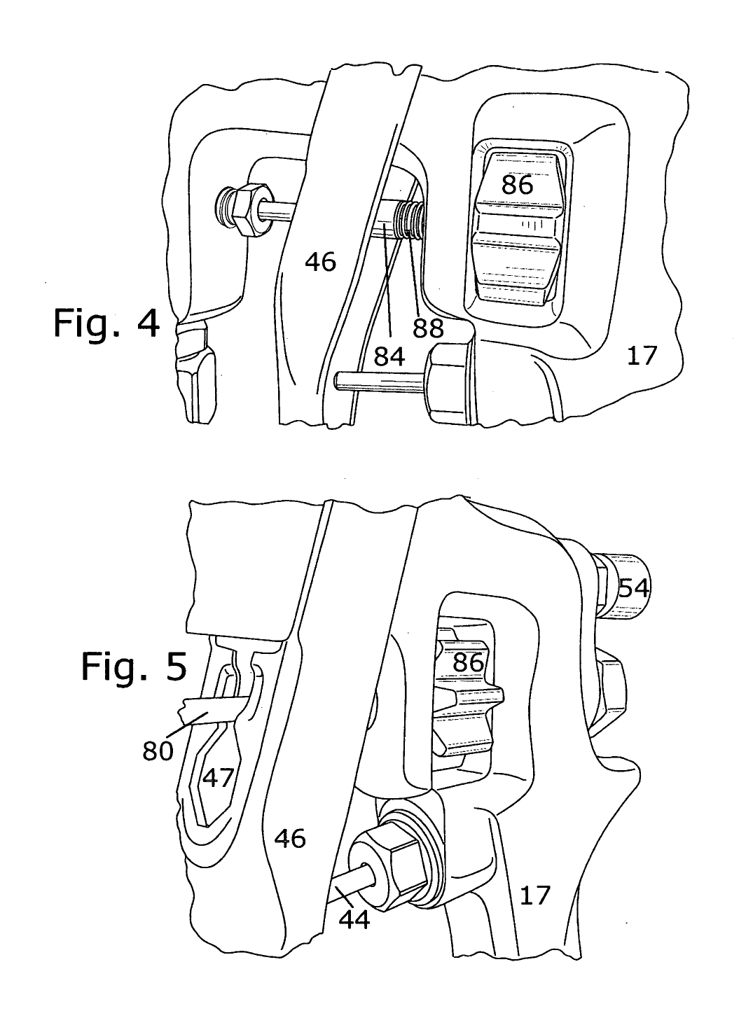

The novel finger adjustment wheel 86 of the present invention 10 and its accessory components are most clearly shown in FIGS. 3 through 5. Specifically, a needle valve sleeve 82 is slidably mounted coaxially about the needle valve screw 80 and threadably fixed within the pistol grip 17 such that the distal portion of the sleeve 82 comprising a needle valve sleeve shoulder 84 functions as a trigger stop whereby it engages and thereby limits the movement of the trigger 46. As clearly shown in FIGS. 3 through 5, the finger adjustment wheel 86 is mounted in the pistol grip 17 such that it can easily be accessed by the user with the same hand gripping the apparatus 10 of the present invention. The wheel 86 is in communication with the needle valve sleeve 82 such that rotation of the wheel 86 and resulting axial rotation of the needle valve sleeve causes longitudinal, reciprocal movement of the needle valve sleeve shoulder 84 pursuant the longitudinal translation of rotational motion by the threaded proximal portion 88 of the needle valve sleeve. As shown in detail in FIGS. 4 and 5, the trigger 46 includes a trigger aperture 47 sized to allow unimpeded passage of the needle valve screw 80 but sized such that the travel of trigger 46 is limited by the position of the needle valve sleeve shoulder 84. Therefore, in use, manipulation of the finger adjustment wheel 86 causes reciprocal movement of the needle valve sleeve shoulder 84 to limit movement of the trigger 46 such that the spray pattern is not dependant on the user's ability to modulate the position of the trigger 46. Rather, the user can simply pull the trigger 46 until it bears on the needle valve sleeve shoulder 84 with the result that the spray pattern of the device 10 may be controlled by the finger adjustment wheel 86 resulting in easily repeatable and consistent spray patterns.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1) A spray gun comprising:
liquid container means;
compressed gas introduction means;
a chamber in communication with said liquid container means and said compressed gas introduction means;
a trigger and trigger mediated valve controlling said compressed gas introduction means; and,
adjustment means comprising a finger adjustable wheel mediating movement of said trigger and trigger mediated valve.

2) A spray gun as claimed in claim 1 wherein said adjustment means is accessible by the gripping hand.

3) A spray gun as claimed in claim 2 wherein said finger adjustable wheel mediates the longitudinal position of a motion limiting sleeve having a motion limiting shoulder selectably bearing on and limiting the travel of said trigger.

4) A spray gun as claimed in claim 1 wherein said adjustment means further comprises a trigger stop.

5) A spray gun as claimed in claim 1 wherein said liquid container means is a siphon-type liquid reservoir means.

6) A spray gun as claimed in claim 1 wherein said liquid container means is a gravity-fed-type liquid hopper means.

7) A spray gun as claimed in claim 1 wherein said spray gun is a high volume low pressure spray gun.

8) A spray gun as claimed in claim 1 wherein said chamber in communication with said liquid container means and said compressed gas introduction means further comprises a nozzle.

9) A spray gun comprising:
liquid container means;
compressed gas introduction means;
a chamber in communication with said liquid container means and said compressed gas means, said chamber further comprising a nozzle;
a trigger and trigger mediated valve controlling said compressed gas introduction means; and,
adjustment means mediating movement of said trigger and trigger mediated valve, said adjustment means further comprising a finger adjustable rotatable wheel accessible and rotatable by the gripping hand, said finger adjustable wheel mediating the longitudinal position of a motion limiting sleeve having a motion limiting shoulder selectably bearing on and limiting the travel of said trigger.

10) A spray gun as claimed in claim 9 wherein said adjustment means further comprises a trigger stop.

11) A spray gun as claimed in claim 9 wherein said liquid container means is a siphon-type liquid reservoir means.

12) A spray gun as claimed in claim 9 wherein said liquid container means is a gravity-fed-type liquid hopper means.

13) A spray gun as claimed in claim 9 wherein said spray gun is a high volume low pressure spray gun.

14) A spray gun comprising:
liquid container means;
high volume low pressure compressed gas introduction means;
a chamber in communication with said liquid container means and said high volume low pressure compressed gas means, said chamber further comprising a nozzle;
a trigger and trigger mediated valve controlling said compressed gas introduction means; and,
adjustment means mediating movement of said trigger and trigger mediated valve, said adjustment means further comprising a finger adjustable wheel assembly accessible by the gripping hand, said finger adjustable wheel assembly further comprising a needle valve sleeve forming a shoulder at a distal portion, said needle valve sleeve slidably mounted coaxially about a needle valve screw and threadably fixed within gripping means.

15) A spray gun as claimed in claim 14 wherein said finger adjustable wheel mediates the longitudinal position of said needle valve sleeve and said shoulder selectably bears on and limits the travel of said trigger.

16) A spray gun as claimed in claim 14 wherein said adjustment means includes a trigger stop.

17) A spray gun as claimed in claim 14 wherein said liquid container means is a siphon-type liquid reservoir means.

18) A spray gun as claimed in claim 14 wherein said liquid container means is a gravity-fed-type liquid hopper means.
